(19) United States
(12) Patent Application Publication
(10) Pub. No.: US 2008/0030049 A1
(43) Pub. Date: Feb. 7, 2008

(54) Aerodynamic drag reducing system for pickup truck

(76) Inventor: Kevin R. Cooper, Ottawa (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, omitted

(21) Appl. No.: 11/498,086

(22) Filed: Aug. 3, 2006

(51) Int. Cl. B62D 35/00

(52) U.S. Cl. 296/180.1

(57) ABSTRACT

An aerodynamic drag reducing system for a pickup truck involves a rear box cover covering at least part of the box, and, an air-flow guide on the cab of the pickup truck which guides air flow to the rear box cover. In one aspect, the rear box cover may be rotatably mounted to the inside face of the tailgate so that it may be conveniently folded in for storage or out for use.

### FIELD OF THE INVENTION

The present invention relates to an aerodynamic drag reducing system for pickup trucks.

### BACKGROUND OF THE INVENTION

Current Corporate Average Fuel Economy (CAFÉ) standards stipulate the average fuel economy of all the vehicles produced by each manufacturer. Once the CAFÉ limit is reached, the manufacturer faces large financial penalties for increasing the average fuel consumption of its fleet by producing more high-profit-margin, but fuel-consuming vehicles, like pickup trucks. Being able to lower the fuel consumption by even a few percent permits many more trucks to be built without penalty.

Lowering fuel consumption may be accomplished by reducing aerodynamic drag on the vehicle. For pickup trucks, reducing drag is complicated by the shape of the truck. Pickup trucks have a raised cab area forward of an open-top box having a flat bed. The open-top box is bounded by three walls and a tailgate at the rear. The tailgate may be lowered to be substantially coplanar with the bed thereby opening the rear of the box, or it may be raised to be substantially perpendicular to the bed to close off the rear of the box.

It is known that covering the box of a pickup truck either fully or partially with a cover helps reduce aerodynamic drag (U.S. Pat. No. 4,573,730 issued Mar. 4, 1986; Cooper, Kevin, SAE Technical Paper Series, 2004-01-1146, 2004).

Attempts have also been made to reduce aerodynamic drag on pickup trucks by placing air deflectors on the roof of the cab (U.S. Pat. No. 4,159,843 issued Jul. 3, 1979). The air deflector described in U.S. Pat. No. 4,159,843 directs air flow up and away from the truck box to a position behind the pickup truck. It was generally thought that air flow to the box of a pickup truck would increase drag.

Air deflectors have also been used at the back of other vehicles (e.g. cars and semi trailers) in an effort to reduce air drag (U.S. Pat. No. 3,000,663 issued Sep. 19, 1961; U.S. Pat. No. 3,276,811 issued Oct. 4, 1966; U.S. Pat. No. 6,257,654 issued Jul. 10, 2001). Such air deflectors are not used with pickup trucks and do not account for the complications which arise from the open-top boxes of pickup trucks.

Tailgates of pickup trucks have been adapted to pivot from a perpendicular closed position to a position raised above and parallel to the bed (U.S. Pat. No. 5,468,037 issued Nov. 21, 1995), but such arrangements lead to greater drag since the back of the pickup truck is open.

There remains considerable need for an aerodynamic drag reducing system for reducing drag on pickup trucks.

### SUMMARY OF THE INVENTION

It has now been surprisingly found that a combination of an air-flow guide on a cab together with a rear box cover covering at least part of a box provides an unexpectedly improved reduction in drag on a pickup truck.

There is provided an aerodynamic drag reducing system for a pickup truck, the pickup truck having a cab forward of an open-top box, the system comprising: a rear box cover covering at least part of the box; and, an air-flow guide on the cab to guide air flow toward the rear box cover.

The cab of the truck has a roof and the air-flow guide guides air flowing over the roof down toward the rear box cover, increasing the base pressure on the cab, thereby reducing aerodynamic drag on the pickup truck. The rear box cover alone can reduce aerodynamic drag coefficient by over 4%. The air-flow guide in combination with the rear box cover can reduce drag by a further 1% or more. Although such drag reductions may seem small, representing about 200 liters of fuel over the life of the pickup truck, and not greatly benefiting individual pickup truck owners, the benefit to pickup truck manufacturers is large since their largest-selling, most profitable vehicles are often pickup trucks.

Preferably, the air-flow guide is located at or proximal a rear upper edge of the cab. Preferably, the air-flow guide extends rearwardly and down from the rear upper edge of the cab. The air-flow guide may be, for example, a single solid piece, a single piece having a plurality of slots, or a plurality of separate pieces spaced-apart or abutting. Preferably, the air-flow guide is a single solid piece. The air-flow guide may extend the entire width of the cab from one side of the cab to the other side, or it may be shorter than the width of the cab. Preferably, the air-flow guide extends the entire width of the cab. The air-flow guide may be integrally formed as part of the cab, or it may be a separate piece or pieces mounted on the cab with mounting means (e.g. bolts, adhesive, welding).

Preferably, the air-flow guide extends rearwardly and downwardly entirely in or below a horizontal plane defined by the roof of the cab. The air-flow guide forms an angle with the horizontal plane defined by the roof of the cab, the angle permitting the air-flow guide to guide air flow toward the rear box cover rather than to a position behind or in front of the rear box cover. The angle is preferably in a range of from about 5° to about 20°, more preferably from about 5° to about 15°. Optimum angle may depend on bed length and/or cab shape, bed length likely being the primary factor as it was the primary factor on the effect of removing tailgates.

The open-top box comprises a tailgate, side walls and a bed having a bed length. The rear box cover may cover all or part of the box. Preferably, the rear box cover covers the box from the tailgate to a position between the tailgate and the cab. Preferably, the rear box cover can cover the box in a range of from about 5% to about 39% of the bed length, more preferably from about 15% to about 39%. Coverage may be a certain fixed fraction of the bed length that falls within the range, or coverage may be adjustable over a part or all of the range. Although the rear box cover may be inclined above or below the top of the tailgate and box, preferably the rear box cover is substantially flush with the top of the tailgate and box. An enclosed storage volume may be created by closing off the front opening at the position where the rear box cover ends, but it is preferable to leave the front opening open since closing it increases drag.

The rear box cover may be hard or soft, for example, the rear box cover may be fabric, vinyl, fiberglass, aluminum, stainless steel, ABS plastic, or any other suitable material. The rear box cover may be a single piece, or a plurality of pieces attached or unattached to each other. Moving the rear box cover between a covering position and a storage position may be accomplished by simply putting it on and taking it off the box; and/or the rear box cover may be extensibly and retractably mounted on the pickup truck. For example, the rear box cover may roll out from or fold away from the tailgate and/or side of the box. Moving the rear box cover between the covering and storage positions may be accomplished automatically with raising and lowering the tailgate.

In one embodiment, the rear box cover comprises a single panel or a plurality of panels. Where the rear box cover comprises a plurality of panels, the panels may be unattached or attached to each other. Attached panels may be foldably attached, for example by a hinge, to facilitate adjusting rear box cover length and/or storing the rear box cover, preferably in the tailgate. For a plurality of panels, any or all of the panels may have the same length or may have differing lengths. Where the rear box cover comprises first and second panels, the second panel is preferably foldably attached to and shorter than the first panel.

Preferably the rear box cover is mounted on an inner face of the tailgate so that the rear box cover can fold or roll out from the inner face when the tailgate is raised, and can fold flush with or roll into the tailgate when the tailgate is lowered. Thus, when panels are used, the largest panel of the rear box cover is preferably no larger than the inner surface of the tailgate. In such an arrangement, one end of the rear box cover may be mounted at the tailgate and another end of the rear box cover may comprise a support for supporting the other end of the rear box cover. Supports may comprise, for example, articulating arms, pins (e.g. spring-loaded pins), clamps, or any other arrangement for securing the other end of cover in a box covering position. Actuation of the support may be accomplished manually and/or automatically. Such an arrangement is simple, small and light, facilitates storage of the rear box cover, can be automatically operated with the tailgate, and ensures that the rear box cover is always with the truck.

The aerodynamic drag reducing system may be included on the pickup truck as part of the manufacturing process, or it may be installed on the pickup truck as an after-market accessory.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a side view of a pickup truck having an aerodynamic drag reducing system of the present invention mounted thereon;

FIG. 2A is a rear side perspective partial view of the pickup truck of FIG. 1 showing a single panel rear box cover of the drag reducing system mounted thereon;

FIG. 2B is a side cross-sectional partial view of the pickup truck of FIG. 2A showing a single panel rear box cover mounted in an unfolded position;

FIG. 2C is a side cross-sectional partial view of the pickup truck of FIG. 2A showing a single panel rear box cover mounted in a folded position;

FIG. 2D is a cross-sectional plan view through the panel of the rear box cover of FIG. 2A showing the single panel rear box cover mounted in an unfolded position;

FIG. 3 is a rear perspective partial view of the pickup truck of FIG. 1 showing one embodiment of an air-flow guide of the drag reducing system mounted thereon;

FIG. 4 is a rear side perspective partial view of a double panel rear box cover mounted on a pickup truck in an alternate embodiment of an aerodynamic drag reducing system; and,

FIG. 5 is a graph of drag coefficient as a function of yaw angle (°) showing results of wind tunnel tests on a pickup truck equipped with and without an aerodynamic drag reducing system of the present invention.

### DESCRIPTION OF PREFERRED EMBODIMENTS

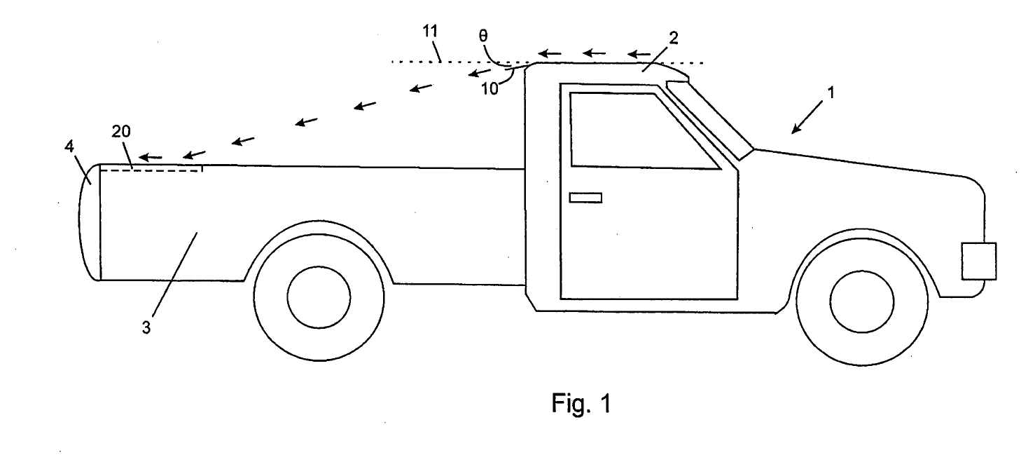

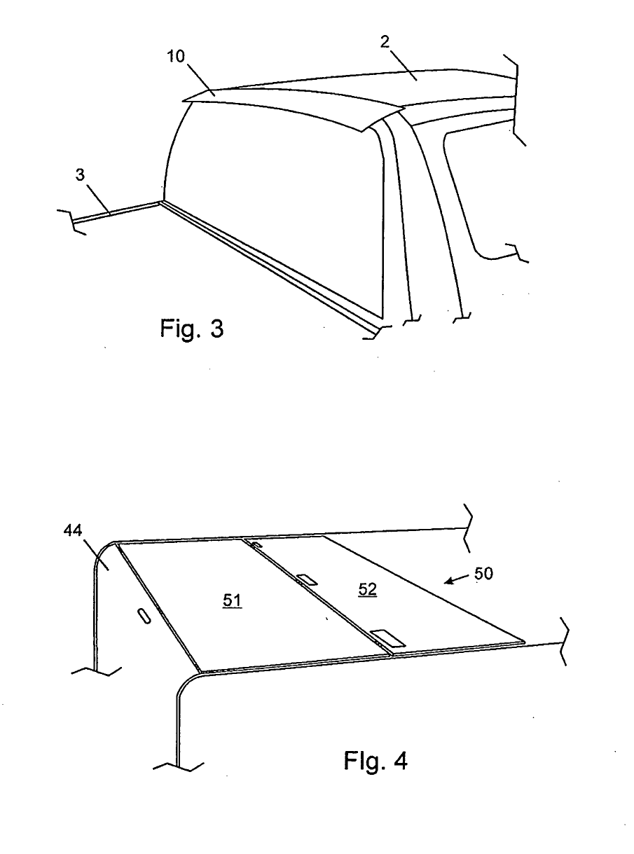

Referring to FIGS. 1 to 3, pickup truck 1, having cab 2, open-top box 3, and tailgate 4, is equipped with an aerodynamic drag reducing system comprising air-flow guide 10 and rear box cover 20. As is most clearly shown in FIG. 3, air-flow guide 10 comprises a single strip of rigid material extending across the entire width of the roof of cab 2 from the driver side to the passenger side, and is mounted at the rear upper edge of the cab. The roof of the cab substantially defines a horizontal plane 11 (FIG. 1). Air-flow guide 10 is angled substantially below the horizontal plane and extends rearwardly and downwardly away from cab 2 at an angle θ with horizontal plane 11. Angle θ is such that air-flow guide 10 guides air flow (shown as a series of arrows in FIG. 1) over the roof of cab 2 down to rear box cover 20. Angle θ is preferably an angle between 50 and 200. Rear box cover 20 comprises a single panel about 50 cm long hingedly mounted to tailgate 4, and is shown in an unfolded position extending from the tailgate toward cab 2 covering about 20% of box 3. Rear box cover 20 is approximately flush with the top of the box and tailgate.

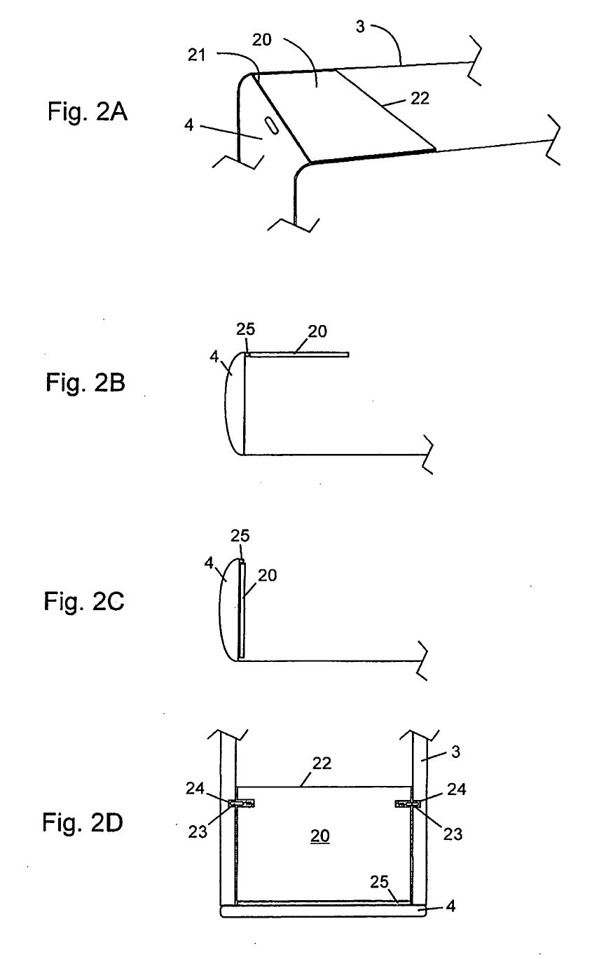

Rear box cover 20 hingedly mounted to tailgate 4 is depicted more clearly in FIGS. 2A-2D. Rear edge 21 of rear box cover 20 is hingedly mounted on tailgate 4 by hinge 25 so that the rear box cover may be unfolded to cover part of the box in an unfolded position (FIG. 2B), or folded down to be stored against the inner face of tailgate 4 in a folded position (FIG. 2C). Rear box cover 20 is smaller than the inner face of tailgate 4 so that the rear box cover can be stored against the inner face making it flush with the floor of the bed of the box. At both sides of rear box cover 20 proximal front edge 22 are spring-loaded pins 23 that engage apertures 24 in the sides of box 3 near the top of the box to support the rear box cover in the unfolded position (FIG. 2D). In the folded position, the spring-loaded pins engage similar apertures (not shown) in the sides of the box near the bottom of the box to secure the rear box cover in the folded position. The spring-loaded pins may be actuated manually and/or automatically. Manual actuation may be accomplished with handles (not shown) attached to the pins. Automatic actuation may be accomplished with solenoids connected to an electrical system.

FIG. 4 depicts an alternate embodiment employing a double panel rear box cover 50 having a 50 cm long first panel 51 hingedly mounted to tailgate 44 and a 25 cm long second panel 52 hingedly mounted to the front edge of the first panel. Spring-loaded pins in the second panel that engage apertures in the box are used to support the rear box cover in the unfolded position and secure the cover in the folded position.

Wind tunnel experiments were conducted to determine the effect of the aerodynamic drag reducing system of the present invention on drag on pickup trucks. Full-sized 2002 Ford F-150 pickup trucks were provided by the NRC ASPM. Drag measurements were made in National Research Council's (NRCs) 9 m×9 m wind tunnel using standard NRC test procedures and data analyses following SAE Wind Tunnel Test Procedures for Trucks and Buses J1252 (1979). Wind-averaged drag coefficients were derived from a set of measurements at different yaw angles to represent wind effects as per SAE J1252. This coefficient provides the annual average drag coefficient of the truck operating all over North America in the average continental wind conditions.

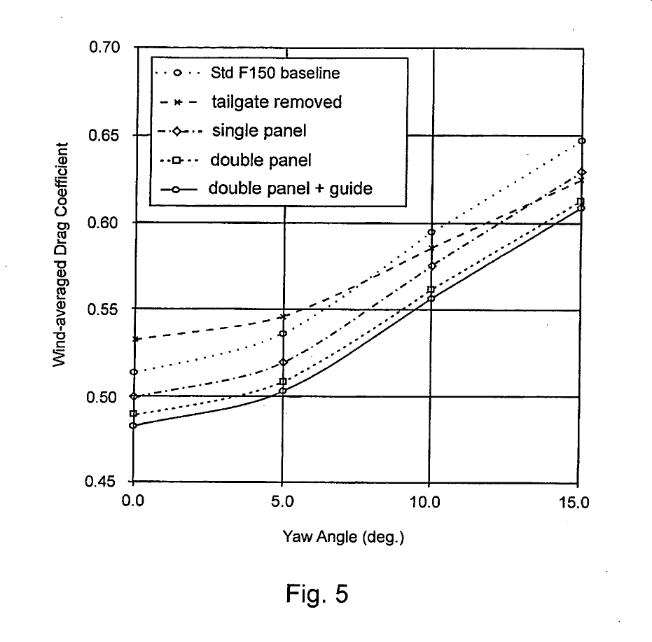

FIG. 5 shows the drag changes due to removal of the tailgate and several combinations of rear box cover panels alone as compared to drag changes due to a drag reducing system of the present invention. The single panel is the width of the box and 51 cm long. The double is a panel that is just less than twice as long as the single panel, which could result from a double hinged panel. The panels extend from the tailgate forward toward the cab. The air-flow guide is a 10-degree guide on the rear upper roof edge of the cab. The bed of the box is 8-feet long so that the panels are 21% and 42% of the length of the bed. It is evident from FIG. 5 that a pickup truck equipped with both a rear box cover and an air-flow guide (i.e. a system of the present invention) provides the greatest reduction in drag.

Wind tunnel experiments were also conducted to determine the effect on drag of various combinations of rear box cover panels, air-flow guide angles and box sizes. Table 1 summarizes the results.

TABLE 1

| | Type | | Wind-averaged |
|---|---|---|---|
| Run | of pickup truck | Configuration | drag reduction (C_{D}) |
| 1 | Extended Cab | 1 panel | 0.0239 |
| 2 | Extended Cab | 2 panels | 0.0244 |
| 3 | Extended Cab | 2 panels + 10° guide | 0.0258 |
| 4 | Extended Cab | 3 panels + 15° guide | 0.0264 |
| 5 | Std. Cab | 1 panel | 0.0144 |
| 6 | Std. Cab | 2 panels | 0.0243 |
| 7 | Std. Cab | 2 panels + 10° guide | 0.0309 |
| 8 | Std. Cab | 3 panels + 17° guide | 0.0286 |

The Extended Cab pickup truck was a 2002 F-150 Extended Cab pickup truck having a box with a bed length of 6.5 feet (short box). The Std. Cab pickup truck was a 2002 F-150 Standard Cab having a box with a bed length of 8 feet (long box). Each panel of the rear box cover was 51 cm long. The panels extended from the tailgate forward towards the cab.

Table 1 shows that the long box (standard cab) gained more from the combination of rear box cover and air-flow guide than the short box (extended cab). The air-flow guide was not optimized for the truck. Table 1 shows that the combination of rear box cover and air-flow guide markedly improves drag reduction over the rear box cover alone.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. An aerodynamic drag reducing system for a pickup truck, the pickup truck having a cab forward of an open-top box, the system comprising: a rear box cover covering at least part of the box; and, an air-flow guide on the cab to guide air flow toward the rear box cover.

2. The system of claim 1, wherein the air-flow guide extends rearwardly and downwardly entirely in or below a horizontal plane defined by a roof of the cab.

3. The system of claim 2, wherein the air-flow guide forms an angle with the horizontal plane in a range of from 5° to 20°.

4. The system of claim 2, wherein the air-flow guide forms an angle with the horizontal plane in a range of from 5° to 15°.

5. The system of claim 1, wherein the air-flow guide is located at or proximal a rear upper edge of the cab.

6. The system of claim 2, wherein the air-flow guide is located at or proximal a rear upper edge of the cab.

7. The system of claim 3, wherein the air-flow guide is located at or proximal a rear upper edge of the cab.

8. The system of claim 1, wherein the box has a tailgate and the rear box cover partially covers the box from the tailgate to a position between the tailgate and the cab.

9. The system of claim 8, wherein the box has a bed having a bed length, and the rear box cover can cover from 5% to 39% of the bed length.

10. The system of claim 8, wherein the box has a bed having a bed length, and the rear box cover can cover from 15% to 39% of the bed length.

11. The system of claim 1, wherein the box has a tailgate having an inner face and the rear box cover is rotatably mounted to the tailgate to fold out from the inner face when the tailgate is raised and to fold flush with the tailgate when the tailgate is lowered.

12. The system of claim 1, wherein the rear box cover is extensibly and retractably mounted on the pickup truck to be movable between a covering position and a storage position.

13. The system of claim 1, wherein the air-flow guide is located at a rear upper edge of the cab and extends rearwardly and downwardly from a horizontal plane defined by a roof of the cab at an angle in a range of from 5° to 20°, and wherein the box has a tailgate and a bed having a bed length, the rear box cover partially covering the box from the tailgate to a position between the tailgate and the cab, the rear box cover able to cover from 5% to 39% of the bed length.

14. The system of claim 13, wherein the angle is in a range from 5° to 15°.

15. The system of claim 13, wherein the rear box cover is able to cover from 15% to 39% of the bed length.

16. The system of claim 13, wherein the angle is in a range from 5° to 15°, and wherein the rear box cover is able to cover from 15% to 39% of the bed length.
